(19) United States
(12) Patent Application Publication
(10) Pub. No.: US 2005/0229192 A1
(43) Pub. Date: Oct. 13, 2005

(54) Disc clamping apparatus and optical disc drive adopting the same

(75) Inventors: Young-sun Jung, Suwon-si (KR); Pil-je Cho, Yongin-si (KR); Kyu-hyeong Lee, Suwon-si (KR); Chung-ung Kim, Yongin-si (KR); Sung-hun Lee, Suwon-si (KR); Young-u Heo, Suwon-si (KR)

Correspondence Address: STAAS & HALSEY LLP, SUITE 700, 1201 NEW YORK AVENUE, N.W., WASHINGTON, DC, 20005, US

(73) Assignee: Samsung Electronics Co., Ltd., Suwon-si (KR)

(21) Appl. No.: 10/988,581

(22) Filed: Nov. 16, 2004

(30) Foreign Application Priority Data
Mar. 30, 2004 (KR) 2004-21571

(51) Int. Cl. G11B 5/52

(52) U.S. Cl. 720/604

(57) ABSTRACT

A disc clamping apparatus that clamps a disc onto a turntable rotated by a spindle motor and an optical disc drive adopting the same. The disc clamping apparatus includes a disc clamping apparatus to clamp a disc onto a turntable rotated by a spindle motor in an optical disc drive, the disc clamping apparatus comprising a plurality of grooves formed along an outer circumference of a hub provided on a center portion of the turntable; a plurality of balls inserted into the plurality of grooves to move toward outsides of the grooves due to a centrifugal force caused by rotation of turntable so as to pressurize the disc. A cover member may be combined with an upper part of the hub to prevent the balls from being separated from the grooves.

### CROSS-REFERENCE TO RELATED APPLICATION

This application claims the priority of Korean Patent Application No. 2004-21571, filed on Mar. 30, 2004, in the Korean Intellectual Property Office, the disclosure of which is incorporated herein in its entirety by reference.

### BACKGROUND OF THE INVENTION

1. Field of the Invention

The present invention relates to an optical disc drive, and, more particularly, to a disc clamping apparatus to clamp a disc onto a turntable rotated by a spindle motor, as well as an optical disc drive adopting a disc clamping apparatus to clamp a disc onto a turntable rotated by a spindle motor.

2. Description of the Related Art

In general, an optical disc drive irradiates a beam onto a a recording medium, such as a compact disc (CD) and a digital versatile disc (DVD), so as to write information to or read information from the recording medium. The optical disc drive includes a disc clamping apparatus that clamps a disc onto a turntable.

FIG. 1 is a perspective view of an optical disc drive with a conventional disc clamping apparatus. FIG. 2 is a cross-sectional view of the optical disc drive of FIG. 1 in which a disc D is clamped onto a turntable 40 by the conventional disc clamping apparatus.

Referring to FIGS. 1 and 2, the optical disc drive includes a main frame 10, an upper case 70 coupled with an upper part of the main frame 10, and a tray 60 that moves the disc D to the inside of the optical disc drive. The disc D moved by the tray 60 is placed on the turntable 40 on a spindle motor 30. The turntable 40 is coupled with a rotating axis 31 of the spindle motor 30 and is rotated together with the rotating axis 31 so as to rotate the disc D. The spindle motor 30 is installed on a pickup deck 20 engaged with the main frame 10. The pickup deck 20 includes an optical pickup 50 that writes information to and reads the information from the disc D.

The optical disc drive further includes a clamping apparatus that clamps the disc D onto the turntable 40 to prevent the disc D from slipping from the turntable 40 when the turntable 40 is rotated. The clamping apparatus includes a clamper 80 on the upper case 70, the clamper 80 allowing the disc D to fixedly contact the upper surface of the turntable 40. A hollow portion 71 is formed to pass through a center portion of the upper case 70, and a supporter 72 is installed to protrude downward from the upper case 70 along an edge of the hollow portion 71. The clamper 80 is inserted into the hollow portion 71 while being supported by the supporter 72. An upper part of the hollow portion 71 is covered with a cover plate 73. A friction pad 41 that gives a friction force to the disc D is attached to the outer surface of the turntable 40. A magnet 42 is installed in the turntable 40, and a metal plate 82 is installed in the clamper 81 to correspond to the magnet 42.

While being placed on the tray 60, the disc D is inserted into the optical disk drive and placed on the turntable 40. When the turntable 40 is elevated, the clamper 80 puts pressure on the disc D in the vertical direction so that the disc D is clamped onto the turntable 40, due to a magnetic force formed between the magnet 42 in the turntable 40 and the metal plate 81 in the clamper 80.

However, a conventional disc clamping apparatus such as that of FIGS. 1 and 2 requires several constitutional elements such as the magnet 42, the metal plate 82, the metal plate 82, the clamp 80, and the cover plate 73. As a result, costs to manufacture and manage conventional disk clamping apparatuses are increased. Also, manufacturing the hollow portion 71 and the supporter 72 in the upper case 70 is relatively difficult and causing the strength of the upper case 70 to be weakened is relatively easy.

### SUMMARY OF THE INVENTION

The present invention provides a disc clamping apparatus with a simple structure, in which a disc is clamped onto a turntable using a centrifugal force caused by rotation of the turntable, and an optical disc drive adopting a disc clamping apparatus with a simple structure, in which a disc is clamped onto a turntable using a centrifugal force caused by rotation of the turntable.

According to one aspect of the present invention, a disc clamping apparatus to clamp a disc onto a turntable rotated by a spindle motor in an optical disc drive comprises a plurality of grooves formed along an outer circumference of a hub provided on a center portion of the turntable; a plurality of balls inserted into the plurality of grooves to move toward outsides of the grooves due to a centrifugal force caused by rotation of turntable so as to pressurize the disc; and a cover member combined with an upper part of the hub to prevent the balls from being separated from the grooves.

In addition, the disc clamping apparatus may further comprise a friction pad attached to an outer upper surface of the turntable to provide a friction force to the disc. At least three grooves are formed along an outer circumference of the hub at equal intervals. The cover member may be configured to cover upper parts of the grooves so as to make that mouths of the grooves be smaller than diameters of the balls. Bottom surfaces of the grooves may be inclined downward toward a center portion of the hub or have flat planes. When the bottom surfaces have flat planes, an outer circumference of the cover member may be inclined downward. The cover member may be adhered to an upper part of the hub via an adhesive or combined with the upper part of the hub via a screw.

According to another aspect of the present invention, an optical disc drive includes a spindle motor that rotates a disc, a turntable combined with a rotation axis of the spindle motor, an optical pickup that irritates a beam on a recording surface of the disc to record information on or reproduce information from the disc, and a disc clamping apparatus that clamps the disc onto the turntable. According to this aspect of the invention, the disc clamping apparatus comprises a plurality of grooves formed in an outer circumference of a hub provided on a center portion of the turntable; a plurality of balls inserted into the plurality of grooves, to move toward outsides of the grooves due to a centrifugal force caused by rotation of the turntable so as to pressurize the disc; and a cover member combined with an upper part of the hub to prevent the balls from being separated from the grooves.

Additional and/or other aspects and advantages of the invention will be set forth in part in the description which follows and, in part, will be obvious from the description, or may be learned by practice of the invention.

### BRIEF DESCRIPTION OF THE DRAWINGS

These and/or other aspects and advantages of the invention will become apparent and more readily appreciated from the following description of the embodiments, taken in conjunction with the accompanying drawings of which:

FIG. 1 is a perspective view of an optical disc drive with a conventional disc clamping apparatus;

FIG. 2 is a cross-sectional view of the optical disc drive of FIG. 1 in which a disc is clamped onto a turntable using the conventional disc clamping apparatus;

FIG. 3 is a perspective view of an optical disc drive with a disc clamping apparatus according to an embodiment of the present invention;

FIG. 4 is an exploded, perspective view of the disc clamping apparatus of FIG. 3;

FIGS. 5A and 5B are cross-sectional views illustrating a process of clamping a disc onto a turntable using the disc clamping apparatus of FIG. 3;

FIG. 6 is a cross-sectional view of a disc clamping apparatus according to another embodiment of the present invention; and

FIG. 7 is a cross-sectional view of a disc clamping apparatus according to yet another embodiment of the present invention.

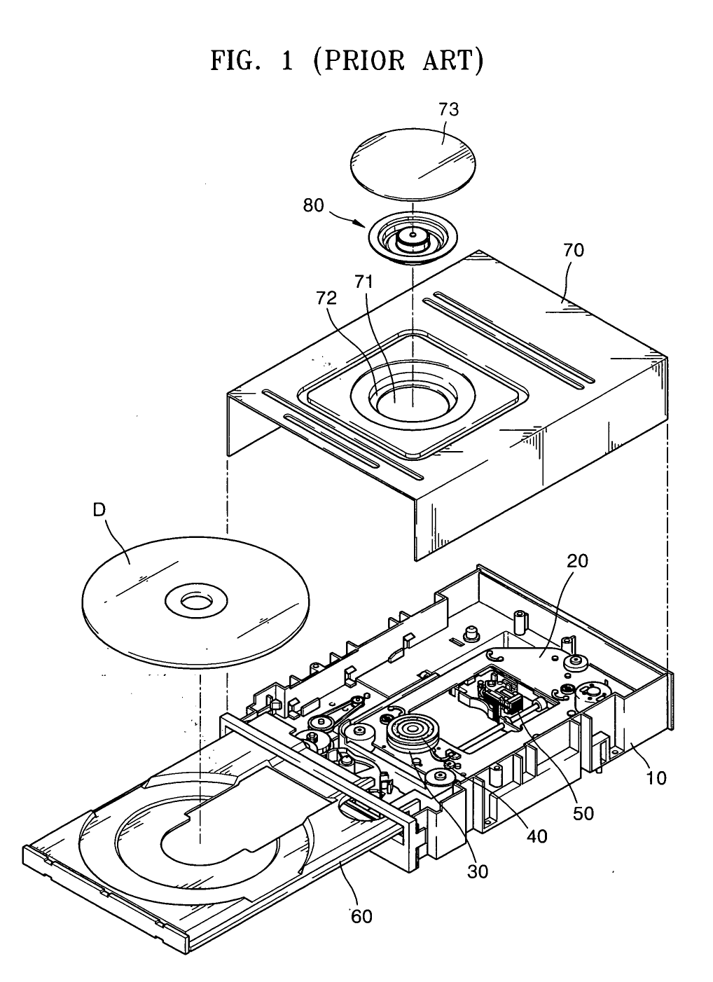

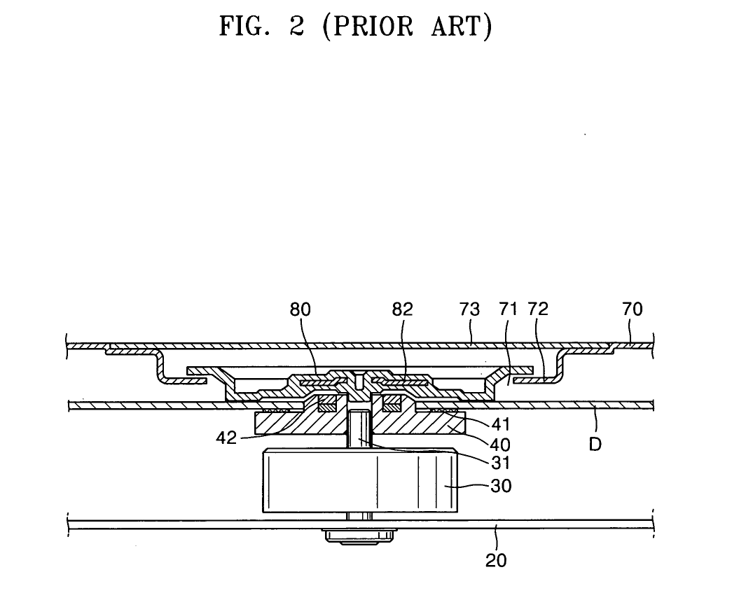

### DETAILED DESCRIPTION OF THE PREFERRED EMBODIMENTS

Reference will now be made in detail to the embodiments of the present invention, examples of which are illustrated in the accompanying drawings, wherein like reference numerals refer to the like elements throughout. The embodiments are described below to explain the present invention by referring to the figures.

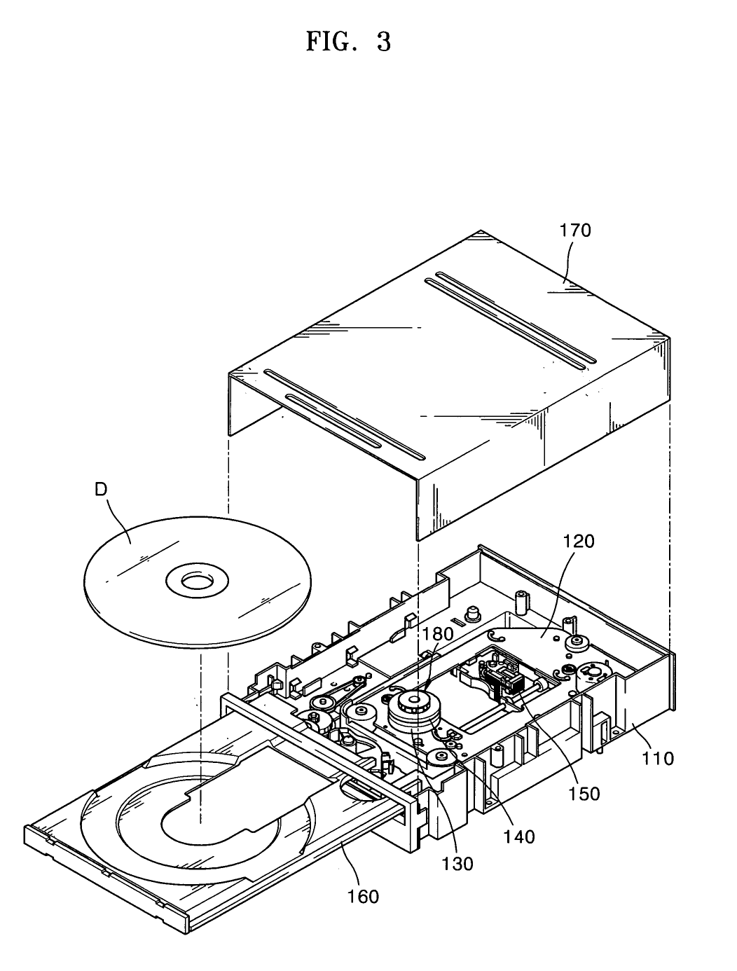

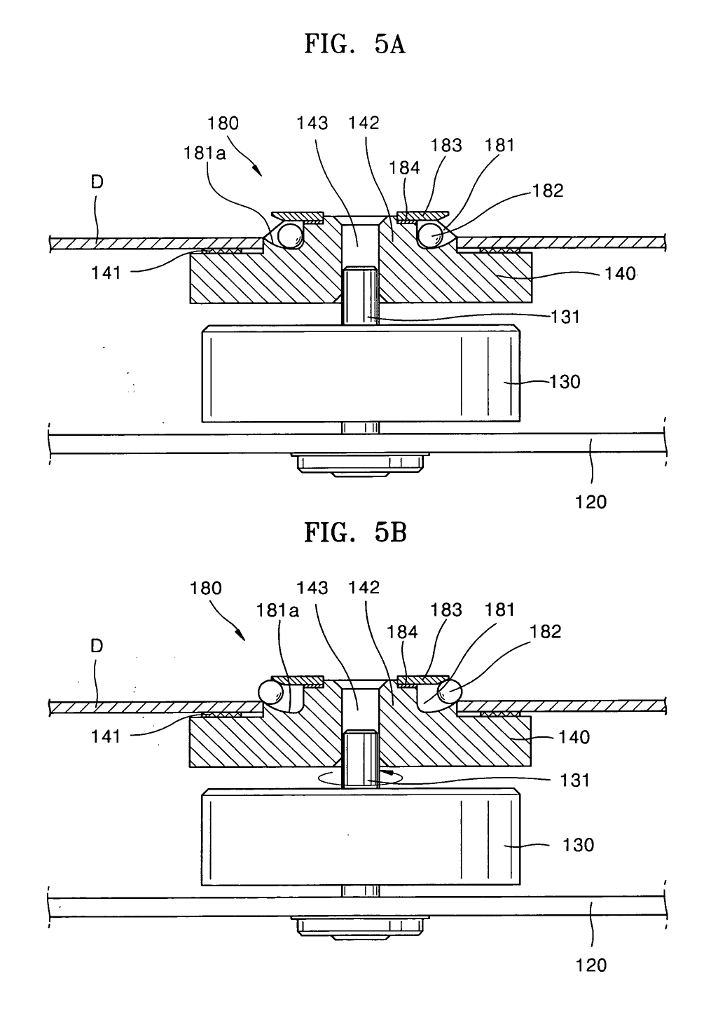

Referring to FIGS. 3 through 5B, an optical disc drive includes a main frame 110, and an upper case 170 coupled with an upper part of the main frame 110. A tray 160 is slidably installed on the main frame 110 so as to move a disc D to the inside of the disc drive. A turntable 140, on which the disc D moved by the tray 160, is placed on the main frame 110. A spindle motor 130 rotates the turntable 140, and a pickup deck 120 supports an optical pickup 150. The optical pickup 150 writes information to and reads information from the disc D. The turntable 140, the spindle motor 130m and the pickup deck 120 are installed in the main frame 110. An end portion of the pickup deck 120 is hinge-coupled to the main frame 110 such that the spindle motor 130 and the turntable 140 may be elevated and lowered. The turntable 140 is coupled to a rotating axis 131 of the spindle motor 130. While being rotated with the rotating axis 131, as shown in FIGS. 5A and 5B, the turntable 140 rotates the disc D. Thus, a rotating axis insertion hole 143, as shown in FIGS. 5A and 5B, passes through a center portion of the turntable 140 in the vertical direction.

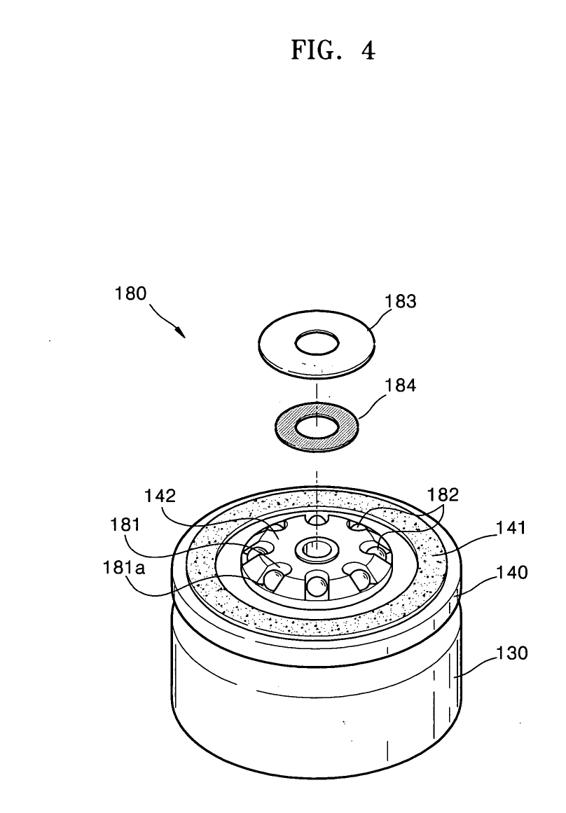

As illustrated in FIGS. 4, 5A and 5B, the turntable 140 includes a disc clamping apparatus 180 that fast fixes the disc D onto the turntable 140 so as to prevent the disc D from slipping from the turntable 140 when the turntable 140 is rotated. In this embodiment, the disc clamping apparatus 180 includes a plurality of grooves 181 that are formed along the outer circumference of a hub 142 of the turntable 140, a plurality of balls 182 inserted into the respective grooves 181, and a cover member 183 coupled with an upper part of the hub 142.

The hub 142 protrudes to a predetermined height from a center portion of the turntable 140. The grooves 181 are formed in the hub 142 along the outer circumference of the hub 142. At least three grooves 181 are formed at substantially equal intervals. The grooves 181 are opened toward the upper surface and outer circumference surface of the hub 142. As shown in FIG. 4, eight grooves 181 may be formed at substantially equal intervals along the outer circumference of the hub 142.

When the turntable 140 is rotated, the balls 182 inserted into the respective grooves 181, are forced to move toward the outside of the grooves 181 due to a centrifugal force caused by the rotation of the turntable 140. The movement of the balls 182 applies pressure in a downward direction onto the disc D placed on the turntable 140 so that the disc D is clamped onto the turntable 140. An effect caused by the movement of the balls 182 will be later described in detail.

The centrifugal force operating on the balls 182 may be expressed with a formula mrw². In this formula, m denotes the mass of an individual ball 182, r denotes the radius of gyration, i.e., the distance between the center of gyration and the center of mass of the ball 182, and w denotes an angular rate of rotation of the ball 182 that is rotated together with the turntable 140 and the hub 142. Accordingly, the centrifugal force operating on the ball 182 is proportional to the mass m, the radius r of gyration, and a square of the rotation angular rate w. In this embodiment, since the external diameter of the hub 142 has been determined, the radius r of gyration is limited. Also, the rotation angular rate w is determined by a speed factor of the disc drive.

Therefore, arbitrarily increasing the centrifugal force operating on the balls 182 is impossible without speeding up the rotation of the turntable. As a result, in order to increase the centrifugal force operating on the balls 182, the mass of the ball 182 is the relatively easiest factor to.

In an embodiment of the invention, one way to increase the mass of the ball 182 is to use a high-density metal material, such as steel, or, more preferably, stainless steel to form the ball 182. Stainless steel is advantageous because stainless steel has relatively excellent anticorrosive properties.

The cover member 183 is coupled to the upper portion of the hub 142. Specifically, the cover member 183 may be adhered to the upper portion of the hub 142 via a predetermined adhesive, e.g., a double faced tape 184. The cover member 183 allows the balls 182 from being separated from the grooves 181. In detail, the cover member 183 is configured to cover tops of the grooves 181 to cause the mouths of the grooves 181 to be smaller than the diameters of the balls 182.

Further, the grooves 181 may be inclined such that their bottom surfaces 181a become low toward a center portion of the hub 142. The shapes of the bottom surfaces 181a of the grooves 181 provide spaces in which the balls 182 may move without contacting the cover member 183. Accordingly, when a centrifugal force is caused by the rotation of the turntable 140, the balls 182 may be moved toward the outside of the grooves 181 without any interference.

In this embodiment, the disc clamping apparatus further includes a friction pad 141 that is attached to the exterior upper part of the turntable 140 to provide a friction force to the disc D. Installation of the friction pad 141 prevents the disc D from slipping from the turntable 140 when the turntable 140 is rotated at a low speed.

An operation of the disc clamping apparatus 180 of FIGS. 5A and 5B will now be described. Referring to FIG. 5A, when the turntable 140 is not rotated, the balls 182 that are inserted into the grooves 181 are not subjected to centrifugal forces. Therefore, the balls 182 are located in the lowest part of the inside of the grooves 181 due to gravity.

Next, as shown in FIG. 5B, when the spindle motor 130 begins to rotate the turntable 140, a centrifugal force, which is proportional to a square of the rotation angular rate, operates on the balls 182 to move them toward the outside of the grooves 181. As a result, the balls 182 contact an upper edge of the inner circumference of the disc D.

While the balls 182 contact the disc D, the centrifugal force operating on the balls 182 is weak and a pressurization force given to the disc D by the balls 182 is also weak when the turntable is rotated at a low speed. In this case, the friction force given by the friction pad 141 is applied to the disc D. However, since the disc D is rotated at a low speed the friction force is able to prevent the disc D from slipping from the turntable 140.

If a rotation speed of the turntable 140 reaches a rated rotation speed, the centrifugal force operating on the balls 182 increases so as to increase the pressurization force applied to the disc D by the balls 182. Accordingly, the disc D is fast fixed onto the turntable 140. In general, a force of about 100 gw is known to be required to stably clamp the disc D with the turntable 140 when the disc D is rotated at a 1× speed. An experiment revealed that installation of a disc clamping apparatus according to the present invention into an optical disc drive applied a force of about 200 gw to the disc D. If the disc D is rotated at a high speed, e.g., at a 50× speed, a centrifugal force operating on the balls 182 is further increased and as a result, a force clamping the disc D onto the turntable 140 is intensified accordingly. Naturally, therefore stably clamping the disc D onto the turntable 140 even when the disc D is rotated at a high speed is possible as a result of this invention.

As is described above, the disc clamping apparatus according to this embodiment allows the disc D to be clamped onto the turntable 140 using a centrifugal force caused by the rotation of the turntable 140. Therefore, the disc clamping apparatus according to this embodiment includes a simpler structure than a conventional disc clamping apparatus. In particular, as shown in FIG. 3, installation of the disc clamping apparatus according to this embodiment into an optical disc drive removes a need to form a hollow portion and a supporter in the upper case 170.

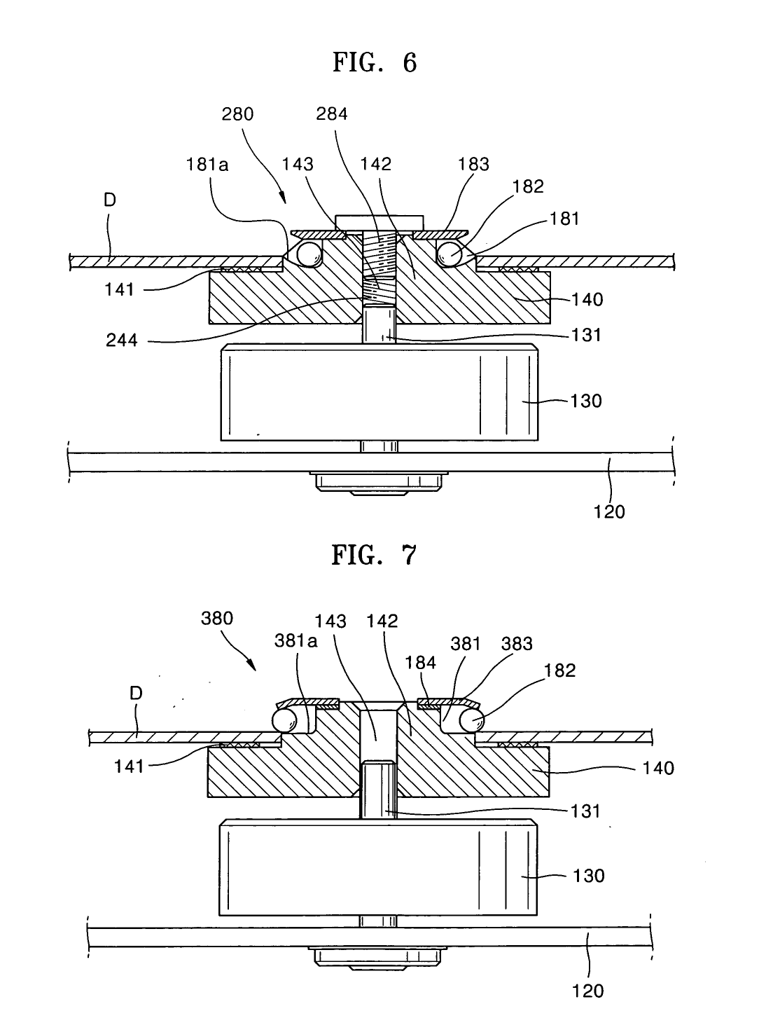

FIG. 6 is a cross-sectional view of a disc clamping apparatus 280 according to another embodiment of the present invention. In this embodiment, the disc clamping apparatus 280 has the same structure as the disc clamping apparatus 180 according to the previous embodiment, except that the present embodiment additionally includes a combining part to combine a cover member 183 and a hub 142. Accordingly, the disc clamping apparatus 280 will now be described with respect to the combining part.

Referring to FIG. 6, the cover member 183 is combined with an upper part of the hub 142 via a screw 284. For the combination, a thread portion 244 is formed in the inside of a rotation axis insertion hole 143 formed in a center portion of the hub 142. Thus, the cover member 183 may be easily combined with the hub 142 by the screw 284 and the thread portion 244 without an adhesive. Also, the screw 284 and the thread portion 244 allow the cover member 183 to easily be separated from or recombined with the hub 142.

Alternatively, the cover member 183 may be combined with the hub 142 via a device, e.g., a hook, other than the screw 284 or the adhesive.

FIG. 7 is a cross-sectional view of a disc clamping apparatus 380 according to yet another embodiment of the present invention. In this embodiment, the disc clamping apparatus 380 has the same structure as the disc clamping apparatus 180 according to the previous embodiment, except that the shape of a cover member 383 and the shape of bottom surfaces 381a of grooves 381, into which balls 182 are inserted, are different.

Referring to FIG. 7, the respective bottom surfaces 381a of the grooves 381 include flat planes. The grooves 381 with the flat bottom surfaces 381a may be manufactured relatively easily in comparison with grooves 181 having inclined bottom surfaces 181a according to the previous embodiment. In addition, according to this embodiment of the invention, the outer circumference of the cover member 383, which is combined with an upper portion of the hub 142 to cover upper parts of the grooves 381, is inclined downward. A distance between the bottom of the cover member 383, excluding the inclined circumference, and the bottom surface 381a is determined to be larger than the diameter of the ball 182 inserted into the groove 381.

The structure of the cover member 383 provides a space in which the ball 182 may move within the grooves 381 without contacting the cover member 383. Also, since the mouth of the grooves 381 are smaller than the diameter of the ball 182, preventing the ball 182 from being separated from the groove 381 is possible.

As is described above, a disc clamping apparatus according to the present invention is advantageous in that the disc clamping apparatus clamps a disc onto a turntable using a centrifugal force that is caused by rotation of the turntable. Thus, the disc clamping apparatus has a simpler structure than a conventional disc clamping apparatus. Further, manufacturing and management costs of the disc clamping apparatus may be reduced.

Also, an optical disc drive adopting the disc clamping apparatus according to the present invention does not require formation of a hollow portion and a supporter in an upper case. Thus, a process of manufacturing the upper case and maintaining the strength of the upper case is simplified.

Although a few embodiments of the present invention have been shown and described, it would be appreciated by those skilled in the art that changes may be made in these embodiments without departing from the principles and spirit of the invention, the scope of which is defined in the claims and their equivalents.

1. A disc clamping apparatus to clamp a disc onto a turntable that is rotated by a spindle motor in an optical disc drive, the disc clamping apparatus comprising:
a plurality of grooves formed along an outer circumference of a hub provided on a center portion of the turntable;
a plurality of balls inserted into the plurality of grooves to move toward outsides of the grooves due to a centrifugal force caused by rotation of turntable so as to pressurize the disc; and
a cover member combined with an upper part of the hub to prevent the balls from being separated from the grooves.

2. The disc clamping apparatus of claim 1, further comprising a friction pad attached to an outer upper surface of the turntable to provide a friction force to the disc.

3. The disc clamping apparatus of claim 1, wherein at least three grooves are formed along an outer circumference of the hub at substantially equal intervals.

4. The disc clamping apparatus of claim 1, wherein the cover member is configured to cover upper parts of the grooves such that mouths of the grooves are smaller than diameters of the balls.

5. The disc clamping apparatus of claim 1, wherein bottom surfaces of the grooves are inclined downwardly and toward a center portion of the hub.

6. The disc clamping apparatus of claim 1, wherein bottom surfaces of the grooves have flat planes.

7. The disc clamping apparatus of claim 6, wherein an outer circumference of the cover member is inclined downward.

8. The disc clamping apparatus of claim 1, wherein the cover member is adhered to an upper part of the hub via an adhesive.

9. The disc clamping apparatus of claim 1, wherein the cover member is combined with the upper part of the hub via a screw.

10. An optical disc drive having a spindle motor that rotates a disc, a turntable combined with a rotation axis of the spindle motor, an optical pickup that irritates a beam on a recording surface of the disc to record information on or reproduce information from the disc, and a disc clamping apparatus that clamps the disc onto the turntable, wherein the disc clamping apparatus comprises:
a plurality of grooves formed in an outer circumference of a hub provided on a center portion of the turntable;
a plurality of balls inserted into the plurality of grooves to move toward outsides of the grooves due to a centrifugal force caused by rotation of the turntable so as to pressurize the disc; and
a cover member combined with an upper part of the hub to prevent the balls from being separated from the grooves.

11. The optical disc drive of claim 10, wherein the disc clamping apparatus further comprises a friction pad attached to an outer upper surface of the turntable to provide a friction force to the disc.

12. The optical disc drive of claim 10, wherein at least three grooves are formed along an outer circumference of the hub at substantially equal intervals.

13. The optical disc drive of claim 10, wherein the cover member is configured to cover upper parts of the grooves such that mouths of the grooves are smaller than diameters of the balls.

14. The optical disc drive of claim 10, wherein bottom surfaces of the grooves are inclined downwardly and toward a center portion of the hub.

15. The optical disc drive of claim 10, wherein bottom surfaces of the grooves have flat planes.

16. The optical disc drive of claim 15, wherein an outer circumference of the cover member is inclined downwardly.

17. The optical disc drive of claim 10, wherein the cover member is adhered to an upper part of the hub via an adhesive.

18. The optical disc drive of claim 10, wherein the cover member is combined with the upper part of the hub via a screw.

19. A disc clamping apparatus to clamp a disc onto a rotatable turntable having a hub provided on a center portion thereof, the disc clamping apparatus comprising:
a plurality of substantially radial grooves at an outer circumference of the hub such that a lower edge of each of the grooves is substantially coplanar with an upper surface of the disc;
a plurality of balls one of which being inserted into each one of the plurality of grooves, each of the balls having a diameter which is shorter than a diameter of the associated groove and longer than a mouth of the associated groove such that, when the turntable rotates, each ball moves to a position at which each ball contacts the disc.

20. The disc clamping apparatus according to claim 19, wherein the grooves are separated by substantially equal intervals.

21. The disc clamping apparatus according to claim 19, wherein the grooves are opened toward an upper surface and outer circumference of the hub.

22. The disc clamping apparatus according to claim 19, further comprising a cover member to cover the mouths of each of the grooves such each of the balls in each of the grooves has a longer diameter than the mouth of the groove.

23. The disc clamping apparatus according to claim 22, wherein the cover member is adhered to the hub via double faced tape.

24. The disc clamping apparatus according to claim 19, wherein when the turntable is rotated, the balls are each acted upon by a centrifugal force caused by the rotation of the turntable and when the balls contact the disc, the balls transform the centrifugal force into a downward force on the disc.

25. The disc clamping apparatus according to claim 19, wherein the grooves are inclined toward the center of the hub such that when the turntable is not rotated, the balls move toward the center of the hub.

26. The disc clamping apparatus according to claim 22, wherein bottom surfaces of the grooves are coplanar with the upper surface of the disc.

27. The disc clamping apparatus according to claim 26, wherein the cover member is inclined downward towards the mouth of the groove.

28. The disc clamping apparatus of claim 19, wherein at least three grooves are formed along an outer circumference of the hub at substantially equal intervals.

29. The disc clamping apparatus according to claim 22, wherein the cover member is integrally combined with the hub.
